(19) United States
(12) Patent Application Publication
(10) Pub. No.: US 2007/0183341 A1
(43) Pub. Date: Aug. 9, 2007

(54) WUSB burst acknowledgment management

(76) Inventors: Douglas Lee, Milpitas, CA (US); Daniel Jacobs, San Jose, CA (US)

Correspondence Address: LECROY CORPORATION, 700 CHESTNUT RIDGE ROAD, CHESTNUT RIDGE, NY, 10977, US

(21) Appl. No.: 11/702,305

(22) Filed: Feb. 5, 2007

Related U.S. Application Data
(60) Provisional application No. 60/765,604, filed on Feb. 6, 2006.

(51) Int. Cl. H04J 1/16

(52) U.S. Cl. 370/252; 370/465

(57) ABSTRACT

A method is provided for processing data in accordance with protocol specifications. The method comprises the steps of determining a beginning transmit window, unwrapping the beginning transmit window, determining an end receive window, unwrapping the end receive window, and normalizing the unwrapped end receive window. Thereafter the unwrapped beginning transmit window and the normalized end receive window are compared, and an acknowledgement segment is generated based upon the comparison.

### CROSS-REFERENCE TO RELATED APPLICATION

This applications claims the benefit under 35 USC 119(e) of U.S. Provisional Patent Application No. 60/765,604, filed Feb. 6, 2006 titled WUSB Burst Acknowledgment Management.

### FIELD OF THE INVENTION

This invention is related generally to the testing of Ultra-Wideband devices and transmissions therebetween, and more particularly to a portable or other Ultra-Wideband (UWB) test and debug platform that preferably combine non-intrusive recording with extensive decoding features.

### BACKGROUND OF THE INVENTION

Ultra-Wideband Technology

UWB technology has been available for over 40 years for military and civilian applications and was originally referred to as either impulse radio or carrier-free communications. More recently, the FCC definition for UWB includes any radio technology with a spectrum that occupies greater than 20 percent of the center frequency or a minimum of 500 MHz. In 2002, the FCC allocated unlicensed radio spectrum from 3.1 GHz to 10.6 GHz expressly for enterprise and consumer applications. The FCC defined a specific minimum bandwidth of 500 MHz at a −10 dB level. As current UWB implementations allow communication that requires high data rates over short distances, one immediate UWB application is WPAN (Wireless Personal Area Network).

Multi-band OFDM technology, promoted by the WiMedia Alliance, is one technology that can utilize the allocated band for UWB. The MB-OFDM transmits data simultaneously over multiple carriers spaced apart at precise frequencies. This approach provides benefits like high spectral flexibility and resiliency to RF interference and multi-path effects. These WiMedia UWB specifications are available from the WiMedia Alliance. The URL for the WiMedia website is http://www.wimedia.org

WiMedia UWB Specification Ecosystem

The WiMedia Alliance has developed specifications for ultra-wide-band (UWB) devices. The main goal of the WiMedia UWB specifications is to create a UWB “ecosystem” that allows easy and secure operation and interoperation of UWB devices. The WiMedia UWB specifications have a first-generation data rate of 480 Mbps, which enables a multitude of innovative wireless devices. UWB devices that follow the WiMedia UWB specifications can co-exist in the same physical environment, even if they have unrelated applications.

Markets for two major application types are emerging:
i. Certified Wireless-USB (WUSB)
ii. WiNet

The WiMedia UWB specification first-generation data rate of 480 Mbps provides a basis for delivering WUSB devices that can perform comparably with USB 2.0 devices. The Certified Wireless-USB protocol maintains the same host-device model as the wired USB protocol, but the Certified Wireless-USB protocol makes many optimizations for operating efficiently on a wireless medium.

The first Certified Wireless-USB-protocol products are various Wire Adapter devices, which operate as wired-to-wireless bridges. Host Wire Adapters (HWA) enable any PC with USB 2.0 to become a WUSB Host. Device Wire Adapters (DWA) are wireless hubs that can connect wired USB 2.0 devices to a WUSB Host. The WUSB specification is available from the USB Implementers Forum (USB-IF). The URL for the USB-IF website is: http://www.usb.org/home

WiNet is a protocol that uses the services of the WiMedia MAC for data networking. The WiNet protocol uses the MUX sublayer and service defined in the WiMedia MAC specification. The MUX sublayer combined with the WiNet protocol corresponds to the logical link control sublayer of the standard ISO/OSI IEEE 802 reference model. For more information about the WiNet protocol, MUX sublayer and service, and WiMedia MAC specification, see the WiNet specification at www.WiMedia.org.

As with all electronic devices, there is a need to be able to properly test various devices to confirm that they conform to a desired standard. further, when in operation, it may be necessary to debug or troubleshoot any communication or operational problems that arise. Therefore it would be beneficial to provide an improved method and apparatus that allow for this type of testing to be performed in accordance with this new standard.

### SUMMARY OF THE INVENTION

Therefore, in accordance with the invention, a test and measurement apparatus is provided that provides full protocol decoding from low-level packets to high-level Wire Adapter transfers for Wireless-USB-protocol devices. It is also contemplated that to the extent any other protocol definitions employ similar attributes, the features of the invention would be applicable thereto.

Furthermore, in accordance with a first aspect of the invention, the inventors of the present invention have recognized that in Wireless USB (WUSB), a transmitter may transmit multiple data packets during a data phase of a transaction. This is known as data bursting. Each data packet in the burst is a segment of a data payload. WUSB uses its own data segmenting and acknowledgement mechanism rather than the one defined in the WiMedia MAC specification.

The WUSB transaction protocol has robust support for failed transmission and reception. In case of such failures, packets must be retransmitted. Protocol analysis software must recognize these failures and retransmissions in order to correctly present a logical view of the transferred data.

In WUSB, a host and device must maintain a Receive Window and a Transmit Window. The Receive Window is a bit vector (up to 32 bits) that indicates the data segments the receiver is prepared to receive. Similarly, the Transmit Window is a bit vector (up to 32 bits) that indicates the data segments the transmitter is prepared to transmit. When a transmitter sends data (according to its Transmit Window) to a receiver, the receiver should respond back with its current Receive Window. The transmitter can then determine if it can advance its Transmit Window or if it needs to retransmit a data segment. For more details, this information is provided in section 5.4 of the Certified WUSB specification.

Therefore, in accordance with this first aspect of the invention, protocol analysis software analyzes the burst acknowledgement bits vectors that are transmitted as part of WUSB transactions. The outcome of the analysis is a list of data segments in the transaction that were successfully received by the transaction recipient. Due to the nature of a wireless medium, protocol analysis software must always consider the possibility that the analyzer captures slightly different traffic than that received by the DUT. By performing an analysis in accordance with the invention, it is possible to determine which data segments are valid and should be reported to higher protocol levels.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 depicts an example of difficulty in unwrapping an ending receive window;

FIG. 2 is a flowchart depicting the processing flow for implementation of a process in accordance with the invention that remedies the problems noted with respect to FIG. 1;

FIG. 3 depicts a memory array utilized to implement the processing in accordance with the invention employing the processing steps of FIG. 2;

FIG. 4 depicts a flowchart diagram showing processing of transactions of FIG. 2;

FIG. 5 is a flowchart diagram depicting processing of the process windows shown in FIG. 4; and

FIG. 6 is a flowchart diagram depicting processing of the normalize process shown in FIG. 5.

### DETAILED DESCRIPTION OF THE PREFERRED EMBODIMENTS

In accordance with the first aspect of the invention, the inventor has proposed a method and apparatus for providing a protocol analysis software and/or an associated hardware system that tracks Receive and Transmit Windows in order to correctly reconstruct segmented data payloads when transmitting data in accordance with a WUSB protocol, or other similarly designed protocol, as described above. When processing the above noted windows, there are a number of parameters that are utilized to process the Receive and Transmit windows. These comprise:

1. Beginning Transmit Window—contains the Sequence Numbers of the data segments that the transmitter should transmit.

2. Ending Receive Window—contains the Sequence Numbers of the data segments that the receiver successfully received.

3. Starting Sequence Number—Sequence Number of the first segment in the Beginning Transmit Window that the transmitter should transmit.

4. Maximum Sequence Distance—maximum window size (the maximum number of bits that can be contained in either of the windows). This value will be the same for all transactions between a TX/RX pair. This value is also the maximum number of digits that can be used in a sequence number before the sequence number wraps around in the window back to the zero bit, and effectively overwrites some of the information contained in the window. It is this wrapping situation that is most troubling, and which the invention primarily addresses.

In accordance with the invention the Beginning Transmit Window and the Ending Receive Window are compared. Any overlapping bits indicate segments that were not received successfully and must be retransmitted. However, because the windows can wrap around, it's not straightforward to perform this comparison. The invention therefore employs the Starting Sequence Number and the Maximum Sequence Distance to “unwrap” the windows, making them easier to compare.

In accordance with the invention, a Beginning Transmit Window for a transaction is considered to be an Ending Receive Window from the previous transaction between a particular transmitter/receiver (TX/RX) pair. If this is the first transaction for this TX/RX pair, then the Beginning Transmit Window is constructed from sequence numbers of the data segments involved in the current transaction. The Ending Receive Window for a transaction is defined as the acknowledge (ACK) bit vector that the receiver sends back to the transmitter. This might be contained in a Handshake packet or in a subsequent Wireless Device Transmission Channel Time Allocater (WdtCTA). The Starting Sequence Number is determined from the sequence number of the first data segment in the transaction. The Maximum Sequence Distance is determined by making an initial pass of the trace. This initial pass finds the highest bit set in the ACK bit vectors for each TX/RX pair. It's possible that a TX/RX pair will have a different Maximum Sequence Distance for different ranges of the trace (delineated by connect sequences), so each Maximum Sequence Distance is qualified by the range in which it is valid.

As noted above, it has been determined by the inventor of the present invention that because a window can potentially wrap around and overwrite some data therein if the length of the Starting Sequence Number is greater than the Maximum Sequence Distance, data in the window should be unwrapped before performing any comparisons in order to avoid ambiguities. The Starting Sequence Number and the Maximum Sequence Distance are used to unwrap windows.

If the bit vector representing the Beginning Transmit Window is represented as “v”, Starting Sequence Number is represented as “s”, and Maximum Sequence Distance is represented as “m”, then the following algorithm accomplishes the unwrapping:
((((v>>s)|(v<<(m+1−s)))<<(31−m))>>(31−m))

The algorithm aligns the bits representing the burst sequence numbers so that the first of a sequence is placed at position 0 in the bit array. This enables the analysis algorithm to operate on the representation of the sequence in the same manner regardless of the actual sequence number's value (before this shift, the sequence number corresponds to a specific bit position of the same value as the burst sequence number, e.g. burst sequence # 4 was represented by bit position 4). This is a normalization technique which allows efficient processing of the data by shifting the window to put the start of the window at bit 0.

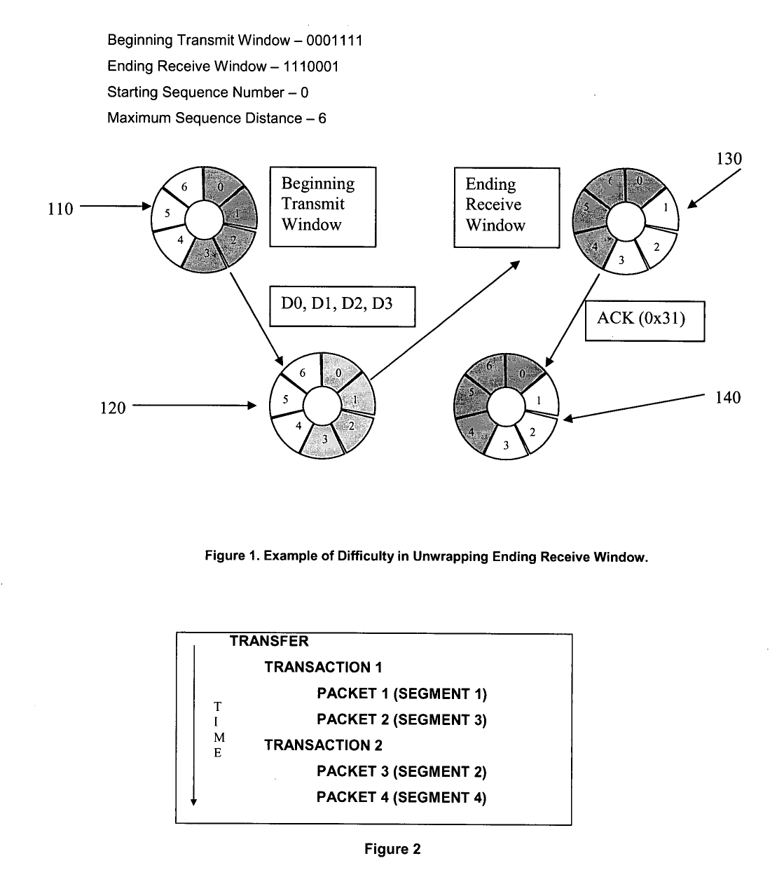

Unwrapping the Ending Receive Window, however, requires some special consideration. This is because a resulting bit vector may be the result of the type of wrapping noted above, but may also in part be a result of bits representative of data that was not properly received. It is important in accordance with this invention to separate and differentiate between the two. Consider the example set forth in FIG. 1. The following parameters have been defined for the example in FIG. 1.
Beginning Transmit Window—0001111— Meaning that the first four data segments are to be transmitted.
Ending Receive Window—1110001— Meaning that (on its face) that the second through data segments have been received as they do not need to be retransmitted.
Starting Sequence Number—0— Meaning that bit zero is where the processing started.
Maximum Sequence Distance—6— Meaning that the largest bit representative of the number of data segments that could be sent at once is six.

In accordance with this example, the transmitter transmits four data segments (shown as bits 0-3 in the Beginning Transmit Window 110, and these bits being transmitted at 120.) and the receiver receives them all successfully. Then the receiver advances it's receive window, indicating that it is ready to receive a next four data segments. However, as noted at 130, when this receive window is advanced, because the maximum sequence number is 6, the last bit in the window (bit #7) must wrap around to bit 0, thus showing as shaded at 130. The receiver then sends its window to the transmitter as data 140, which then updates its own window.

Upon receipt of receive window 130 transmitted as data 140, it would first appear to the transmitter that the receiver didn't receive the first segment successfully because it has asked for that first data segment (segment 0) to be retransmitted. If this were the case, then the transmitter would have to retransmit the first segment, and thus in the next transaction the Starting Sequence Number would still be 0, and the transmitted segments would be the previously transmitted segment zero, and new data segments 4, 5 and 6. In actuality, however, the new Beginning Transmit Window should be 1110001 (same as the receive window 130). Such a transmit Window includes seven bits, and thus the transmit window size would be 7, which exceeds the Maximum Sequence Distance of 6. Thus, in scenarios such as this one, in accordance with the invention it is important to interpret from the Ending Receive Window that the first segment was actually received successfully, therefore avoiding retransmitting a received data segment.

To accomplish this, the process first begins by unwrapping the Ending Receive Window the same way as the Beginning Transmit Window described above. Next, the invention checks if the highest bit is set. If it is then a process is started for clearing bits one-by-one from the low end until a bit that is already cleared has been hit. The process is stopped at this bit because the next set bit after it must represent the Starting Sequence Number for the next transaction. In the example above, this would result in an effective receive window of 1110000. From this window, it's easy to see that the first four data segments were successfully received.

Once it has been determined which data segments were acknowledged by the receiver, it is a straightforward task to collect and reorder them to present them as WUSB Transfer payloads. An array of segment status elements are used to facilitate this reordering. The array is indexed by segment number, and the corresponding status element indicates Received/Not-Received, and it stores a reference to the segment. Once the array is filled, the process then iterates through the array in order and extracts the data from the segment referenced in each element. The extracted data is then added to the destination buffer.

For a given transfer, it is preferred to iterate through its transactions. For each transaction, each acknowledged data segment is collected, and a corresponding element in the status array corresponding to the segment number is updated. It is possible that a duplicate segment number may be encountered before the status array is finished being filled. To handle this scenario, a second status array is provided to handle such duplicates. However, if a triplicate segment number is encountered before the first array is finished being filled, this indicates that an error occurred, and the reordering process will be aborted.

Once the first array is filled, data from corresponding segments are extracted and added to the destination buffer. Then the contents of the second array are copied to the first, the second array is cleared, and processing continues. If iterating through a transfer is completed before the status array is filled, then the elements are iterated through to add the corresponding data to the destination buffer. If while iterating through the array a gap is encountered, then reordering is aborted because data is missing.

Transfer payloads are created on the fly and do not remain in memory. These payloads can be used for decoding purposes or for display.

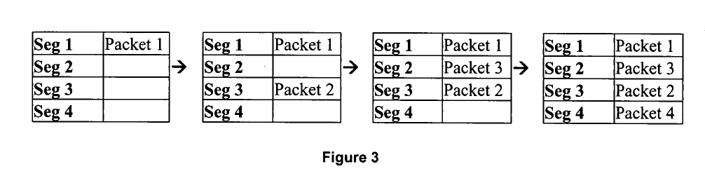

Referring next to FIG. 2, an example of this process is shown. FIG. 2 depicts one Transfer that contains two Transactions, and each Transaction contains two data segments, but any number of transactions and data segments may be employed. In this example, as is depicted in FIG. 3, the segments are not (necessarily) ordered sequentially and indeed are dependent upon the data transmission sequence, and information regarding required retransmission of any particular data segment. The status array would be filled in the order in accordance with the above noted algorithm of the invention (indicating which data segments are transmitted and in which order), and as depicted in FIGS. 2 and 3. Once the array is filled, it is determined in accordance with the invention that the data should be extracted in the following order: Packet 1, 3, 2, 4.

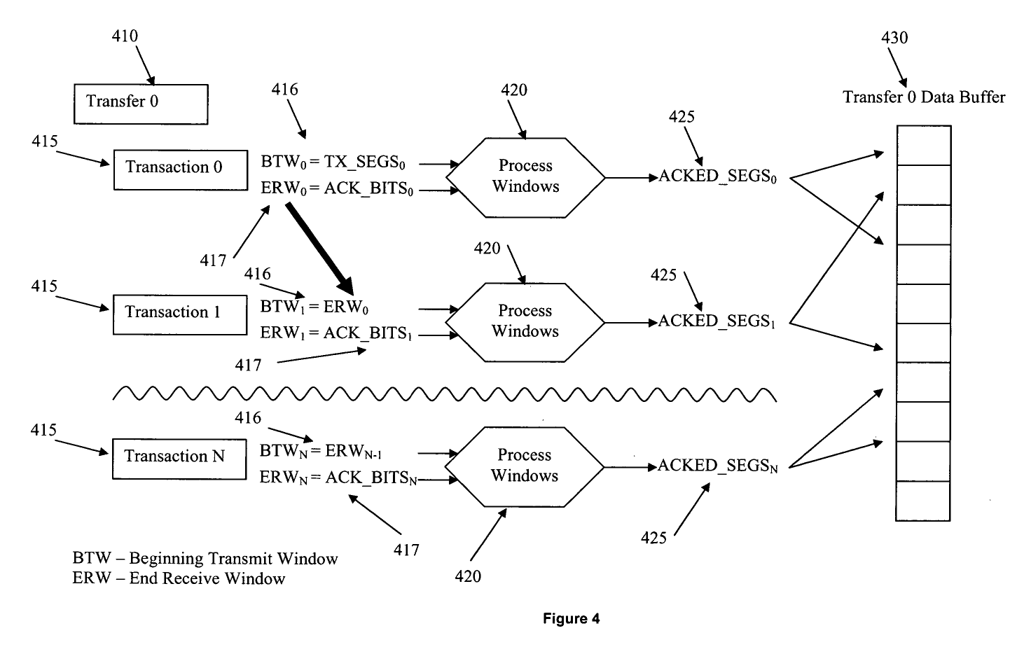

Processing of the data as noted above will no be described in greater detail making reference to FIGS. 4-6. As is shown in FIG. 4, a transfer 410 includes N transactions 415. Each transaction is further defined by a Beginning Transmit window 416 and an End Receive Window 417. As noted above, generally Beginning Transmit Window 416 is defined as the End Receive Window from the prior transaction. For the first transaction 415 (transaction 0), the Beginning Transmit Window is defined as Text Segments from transaction zero. For each transaction, the Beginning Transmit Window 416 and the End Receive Window 417 are employed to further process data contained in the windows, represented by processing step 420, which will be described in greater detail below. After processing, acknowledged segments 425 are generated and are stored in a data buffer 430 corresponding to the current transfer number. As noted with respect to FIG. 3, these segments are stored in other than sequential order.

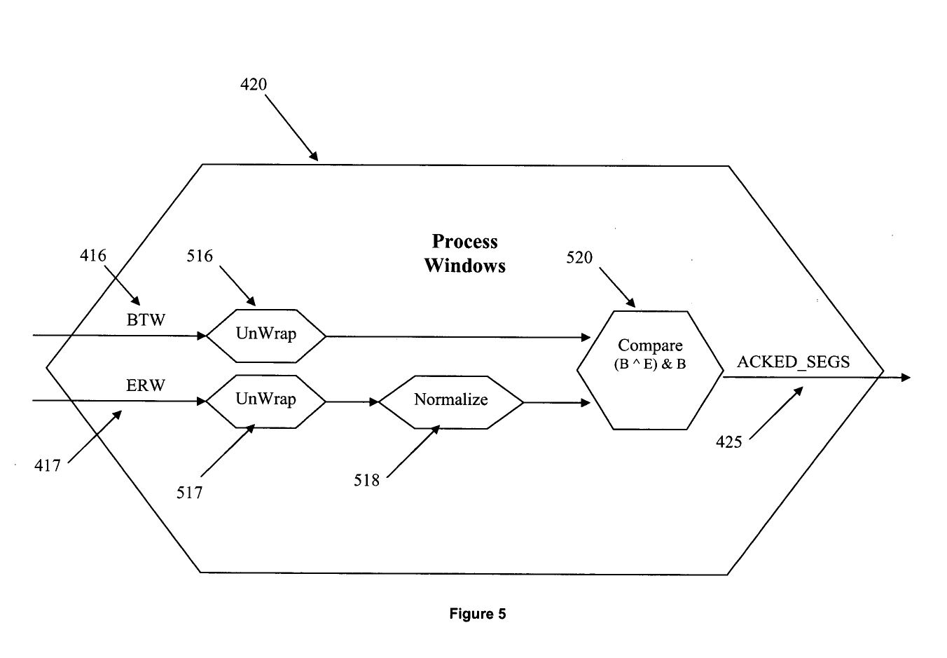

Referring next to FIG. 5, processing taking place within each processing step 420 will be described. Processing step 420 receives Beginning Transmit Window 416 and End Receive Window 417 as noted above. This data is unwrapped at steps 516 and 517, respectively, in the manner described above. Thereafter, as also noted above additional processing is required to normalize the unwrapped End Receive Window information. This processing takes place at step 518, as will be described below in greater detail. After completion of the processing, a bitwise exclusive OR comparison is made between BˆE and B to determine which of the bits are set in both the Begin Transmit Window and End Receive Window to confirm which transmitted burst segments have been properly received, and can therefore be added to the captured data buffer. As a result of this comparison, acknowledged segment 425 is generated and forwarded as described with respect to FIG. 4.

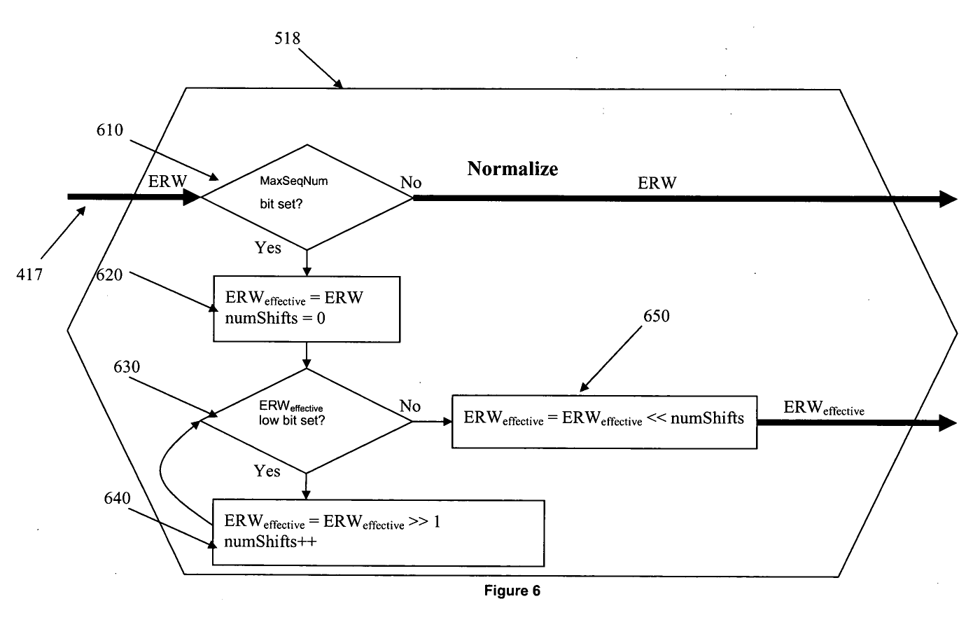

Referring next to FIG. 6, processing taking place within each processing step 518 will be described. End Receive Window 417, after unwrapping via step 517, is provided to a first processing step 610. At step 610 it is queried whether a maximum sequence number has been set. If this inquiry is answered in the negative, and therefore it is determined that such a maximum sequence number has not been set, then End Receive Window 417, as unwrapped in step 517, is output from step 518. If, however, the inquiry is answered in the affirmative, and therefore such a maximum sequence number has been set, processing passes to step 620.

At processing step 620, a value End Receive Window (effective) is set equal to the End Receive Window 417 (after unwrapping) with no number shifts. Processing then passes to step 630. At step 630 it is queried whether the End Receive Window (effective) has a low bit set. If this inquiry is answered in the affirmative and it is determined that the low bit is set, then the current End Receive Window (effective) is replaced with an End Receive Window (effective) with one additional number shift. Processing then returns to step 630. Such processing between step 630 and 640 continues until the inquiry at step 630 is answered in the negative and it is determined that the low bit of the current End Receive Window (effective) is not set. At this time, processing passes to step 650 where the End Receive Window (effective) to be output from process step 518 is set to the current End Receive Window (effective) including the determined number of number shifts. Then this End Receive Window (effective) is output from processing step 518 and is used in the further processing at step 520 as shown in FIG. 5.

Therefore, in accordance with the invention, as noted above, due to the nature of a wireless medium, protocol analysis software must always consider the possibility that the analyzer captures slightly different traffic than that received by the DUT. By performing an analysis in accordance with the invention, it is possible to determine which data segments are valid and should be reported to higher protocol levels.

While the invention has been described applicable to the Certified WUSB protocol, the invention is intended to be equally applicable to other protocol definitions and to electronic apparatuses in general.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A method for processing data in accordance with protocol specifications, comprising the steps of:
determining a beginning transmit window;
unwrapping the beginning transmit window;
determining an end receive window;
unwrapping the end receive window;
normalizing the unwrapped end receive window; and
comparing the unwrapped beginning transmit window and the normalized end receive window;
whereby an acknowledgement segment is generated based upon the comparison.

2. The method of claim 1, wherein the unwrapping steps further comprise the steps of:
placing a first bit of a burst sequence of the beginning transmit window or the end receive window at a predetermined location of a bit array.

3. The method of claim 1, wherein the normalizing step further comprises the steps of:
(a) determining whether a maximum sequence number bit has been set;
(b) determining whether a low bit of the end receive window has been set if it is determined that the maximum sequence number bit has been set;
(c) employing a number shift to the end receive window is it is determined that the low bit of the end receive window has been set;
(d) replacing the end receive window with a number shifted end receive window;
(e) repeating steps (b)-(d) until it is determined in step (b) that the low end bit of the end receive window has not been set; and
(f) outputting the unwrapped end receive window

4. The method of claim 1, further comprising the step of writing the acknowledge segment to a data buffer.

5. The method of claim 1, wherein the steps are repeated for each of a plurality of transaction data making up part of a data transfer.

6. A system for processing data in accordance with protocol specifications, comprising:
a processor, the processor adapted to determine a beginning transmit window, unwrap the beginning transmit window, determine an end receive window, unwrap the end receive window, normalize the unwrapped end receive window; and compare the unwrapped beginning transmit window and the normalized end receive window;
whereby an acknowledgement segment is generated based upon the comparison.

7. The system of claim 6, wherein the processor is further adapted to:
placing a first bit of a burst sequence of the beginning transmit window or the end receive window at a predetermined location of a bit array.

8. The system of claim 6, wherein the processor is further adapted to:
(a) determine whether a maximum sequence number bit has been set;
(b) determine whether a low bit of the end receive window has been set if it is determined that the maximum sequence number bit has been set;
(c) employ a number shift to the end receive window is it is determined that the low bit of the end receive window has been set;
(d) replace the end receive window with a number shifted end receive window;
(e) repeat the processing of steps (b) - (d) until it is determined in step (b) that the low end bit of the end receive window has not been set; and
(f) output the unwrapped end receive window

9. The system of claim 6, wherein the processor is further adapted to write the acknowledge segment to a data buffer.

10. The system of claim 6, wherein the processor is further adapted to repeat the processing for each of a plurality of transaction data making up part of a data transfer.

11. A computer program embodied in a computer readable memory for processing data in accordance with protocol specifications, the computer program comprising instructions for performing the steps of:
determining a beginning transmit window;
unwrapping the beginning transmit window;
determining an end receive window;
unwrapping the end receive window;
normalizing the unwrapped end receive window; and
comparing the unwrapped beginning transmit window and the normalized end receive window;
whereby an acknowledgement segment is generated based upon the comparison and stored to a data buffer.

12. The computer program of claim 11, wherein the unwrapping steps further comprise the steps of:
placing a first bit of a burst sequence of the beginning transmit window or the end receive window at a predetermined location of a bit array.

13. The computer program of claim 11, wherein the normalizing step further comprises the steps of:
(a) determining whether a maximum sequence number bit has been set;
(b) determining whether a low bit of the end receive window has been set if it is determined that the maximum sequence number bit has been set;
(c) employing a number shift to the end receive window is it is determined that the low bit of the end receive window has been set;
(d) replacing the end receive window with a number shifted end receive window;
(e) repeating steps (b)-(d) until it is determined in step (b) that the low end bit of the end receive window has not been set; and
(f) outputting the unwrapped end receive window

14. The computer program of claim 11, wherein the steps are repeated for each of a plurality of transaction data making up part of a data transfer.
